(19) United States
(12) Patent Application Publication
(10) Pub. No.: US 2015/0271029 A1
(43) Pub. Date: Sep. 24, 2015

(54) ACTIVATION MANAGEMENT SYSTEM AND ACTIVATION MANAGEMENT METHOD

(71) Applicant: FUJITSU LIMITED, Kawasaki-shi (JP)

(72) Inventor: Yoshinori IWAMOTO, Yokohama (JP)

(73) Assignee: FUJITSU LIMITED, Kawasaki-shi (JP)

(21) Appl. No.: 14/606,290

(22) Filed: Jan. 27, 2015

(30) Foreign Application Priority Data
Mar. 20, 2014 (JP) 2014-057893

(51) Int. Cl. H04L 12/24; H04L 29/06

(52) U.S. Cl. CPC H04L 41/5041; H04L 63/08

(57) ABSTRACT

An activation management system includes an activation management apparatus including a processor. The processor is configured to start, in response to a first request for accessing from a client device to a target server in a first state of being stopped, user authentication processing for authenticating a user of the client device and transmit a first instruction for bringing the target server into a second state of being operating. The processor is configured to transmit, if the first request is not permitted, a second instruction for bringing the target server in the second state into a third state of being temporarily stopped. The processor is configured to transmit, if a second request for accessing the target server is permitted, a third instruction for bringing the target server in the third state into the second state. The second request is generated after the transmission of the second instruction.

### CROSS-REFERENCE TO RELATED APPLICATION

This application is based upon and claims the benefit of priority of the prior Japanese Patent Application No. 2014-057893, filed on Mar. 20, 2014, the entire contents of which are incorporated herein by reference.

### FIELD

The embodiments discussed herein are related to an activation management system and an activation management method.

### BACKGROUND

In a system environment in which an information processing service is provided, user authentication processing of authenticating a user is performed in response to an access request from a client to a system, and in a case where the user authentication is successfully made, provision of the information processing service to the user is permitted. The system is configured of one or more virtual servers or physical servers, for example.

In such a system, the servers which configure the system are stopped to save usage of resources when the user does not use the information processing service. For example, an authentication server stops the system when the user does not use the information processing service provided by the system, and the authentication server activates the system when an access request to the system in a stopped state is detected.

Related techniques are disclosed in, for example, Japanese Laid-open Patent Publication No. 2012-83825, Japanese Laid-open Patent Publication No. 2004-178466, and Japanese Laid-open Patent Publication No. 2013-84312.

If one or more servers which configure the system are in the stopped state, a server which executes the access request from a client is also in the stopped state. In a case of performing system activation processing in response to a new access request from the client, a time (user waiting time) during which the user is waiting for the service to be started is extended. In addition, the system is activated even in a case where user authentication fails. As described above, it is not easy to efficiently activate and stop the system in accordance with a usage state of the information processing service while shortening the user waiting time.

### SUMMARY

According to an aspect of the present invention, provided is an activation management system including an activation management apparatus. The activation management apparatus includes a processor. The processor is configured to start, in response to a first access request for accessing from a client device to a target server that is in a first state in which the target server is stopped, user authentication processing for authenticating a user of the client device and transmit a first instruction for bringing the target server into a second state in which the target server is operating. The processor is configured to transmit, if the first access request is not permitted as a result of the user authentication processing, a second instruction for bringing the target server that is in the second state into a third state in which the target server is temporarily stopped. The processor is configured to transmit, if a second access request for accessing the target server is permitted, a third instruction for bringing the target server that is in the third state into the second state. The second access request is generated after the transmission of the second instruction.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting a hardware configuration of a system according to an embodiment;

FIG. 2 is a diagram illustrating an example of virtual servers which configure a virtual system;

FIGS. 3A and 3B are diagrams illustrating system activation processing in a case where an access request from a client apparatus is detected;

FIG. 4 is a diagram illustrating a hardware configuration of an authentication server;

FIG. 5 is a diagram illustrating a functional configuration of the authentication server;

FIG. 6A is a diagram illustrating a configuration of a user table region stored on a user authentication DB;

FIG. 6B is a diagram illustrating a configuration of a currently-used-service table region stored on a virtual system management DB;

FIG. 7A is a diagram illustrating a configuration of a service table region stored on the virtual system management DB;

FIG. 7B is a diagram illustrating a configuration of a virtual system operation state table region stored on the virtual system management DB;

FIG. 8 is a diagram illustrating a configuration of a VM table region stored on the virtual system management DB;

FIG. 9 is a flowchart illustrating processing performed by a client apparatus and a virtual system according to the embodiment;

FIG. 10 is a flowchart illustrating activation management processing performed by the authentication server;

FIG. 11 is a flowchart illustrating activation management processing in a case where the virtual servers are in a stopped state;

FIG. 12 is a flowchart illustrating activation management processing in a case where the virtual servers are in a temporarily stopped state;

FIG. 13 is a flowchart illustrating activation management processing in a case where the virtual servers are in an operating state;

FIG. 14 is a flowchart illustrating processing performed by the authentication server after completion of an access of a user to the virtual system;

FIG. 15 is a flowchart illustrating processing of activating the virtual system and releasing temporary stop of the virtual system performed by the authentication server;

FIG. 16 is a flowchart illustrating processing of stopping the virtual system performed by the authentication server; and

FIG. 17 is a flowchart illustrating processing of temporarily stopping the virtual system performed by the authentication server.

### DESCRIPTION OF EMBODIMENTS

Hereinafter, a description will be given of embodiments with reference to the drawings. However, the technical scope of the embodiments is not limited thereto and also includes matters described in claims and equivalents thereto.

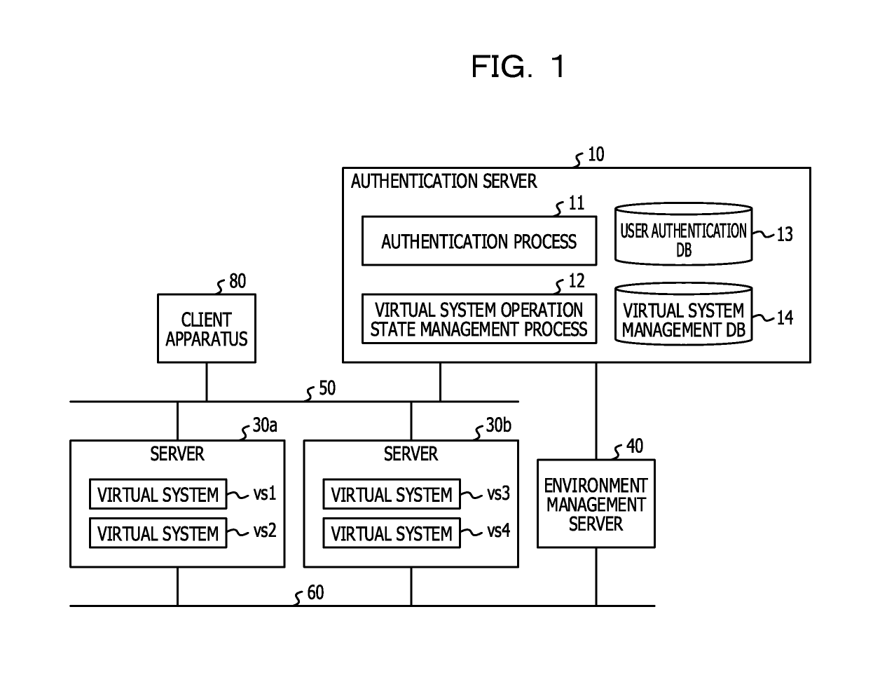

FIG. 1 is a diagram illustrating a hardware configuration of a system according to an embodiment. The system depicted in FIG. 1 is, for example, a private cloud system. The private cloud system is a system which is constructed by a company as their own cloud computing system for providing a cloud service to departments in the company and group companies. The system in FIG. 1 operates a plurality of virtual systems, and an authentication server 10 (activation management apparatus) collectively manages users who use the plurality of virtual systems.

The system depicted in FIG. 1 includes a client apparatus 80, an authentication server 10, an environment management server 40, a first server (physical server) 30a, and a second server (physical server) 30b. The authentication server 10, the client apparatus 80, the first server 30a, the second server 30b, and the environment management server 40 are connected to one another via a communication line 50 such as the Internet.

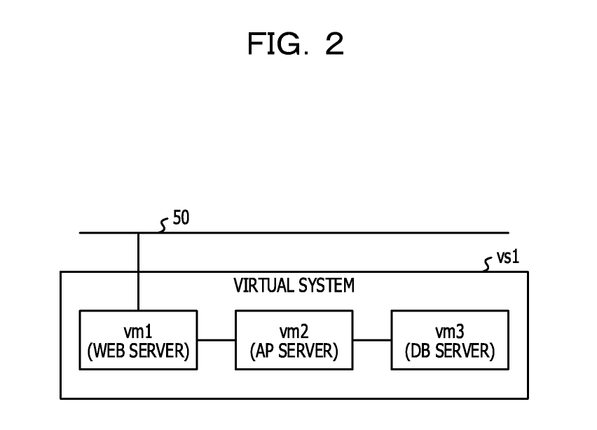

The first server 30a in FIG. 1 runs a virtual system vs1 and a virtual system vs2. The first server 30a is a server including a central processing unit (CPU), a memory, and a communication interface unit. The first server 30a executes control software called a hypervisor. By executing the hypervisor, the first server 30a logically splits hardware resources thereof and generates one or more logical partitions. For each of the logical partitions, the first server 30a executes an operating system (OS) to configure a virtual server (management target server). A detailed description will be given of the virtual server with reference to FIG. 2. Similarly, the second server 30b in FIG. 1 runs a virtual system vs3 and a virtual system vs4.

In the example of FIG. 1, the environment management server 40 operates as a virtual-environment management server for the virtual servers. The environment management server (hereinafter, referred to as a virtual-environment management server) 40 constructs and manages the virtual servers which run on the first server 30a or the second server 30b. The virtual-environment management server 40 constructs and manages multiple virtual servers on the basis of hardware resources allocated to the virtual servers and configuration information including logic information. The virtual-environment management server 40 is a server including a CPU, a memory, and a communication interface unit.

The virtual-environment management server 40 secures the hardware resources of the first server 30a and the second server 30b, which are used by the virtual servers to construct the virtual servers. In addition, the virtual-environment management server 40 performs control such as activation and stopping of the virtual servers on the basis of the configuration information of the virtual servers. The virtual-environment management server 40 is connected to the first server 30a and the second server 30b via a communication line 60 for management and controls the virtual servers running on the first server 30a and the second server 30b.

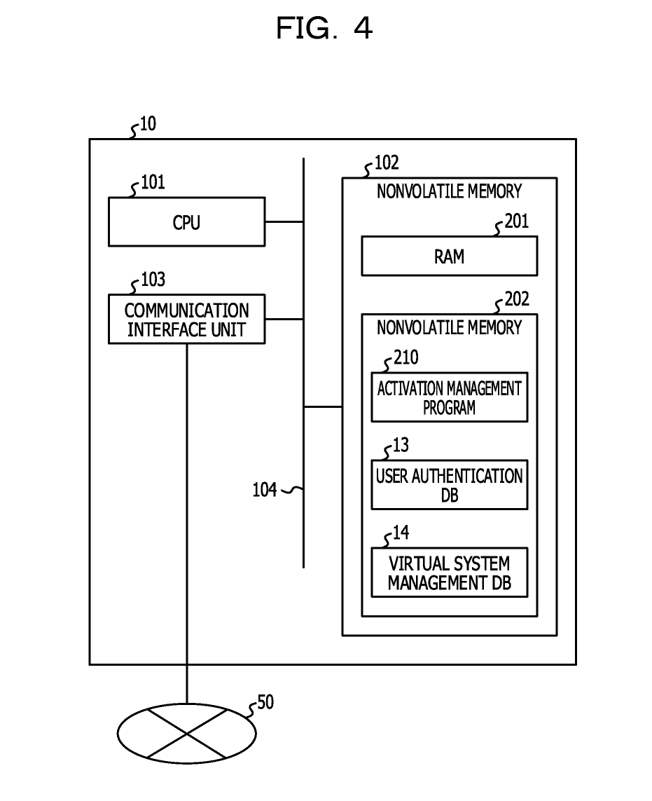

The authentication server 10 in FIG. 1 executes an authentication process 11 for authenticating a user who requests an access to the virtual systems vs1 to vs4. A hardware configuration of the authentication server 10 will be described with reference to FIG. 4. The authentication server 10 includes a storage device which stores a user authentication database (DB) 13 and a virtual system management DB 14.

By executing the authentication process 11, the authentication server 10 refers to the user authentication DB 13 to perform the user authentication processing for each virtual system, in response to an access request to the virtual systems vs1 to vs4 transmitted from the client apparatus 80. Furthermore, by executing a virtual system operation state management process 12, the authentication server 10 controls operation states of the virtual systems vs1 to vs4 via the virtual-environment management server 40. The authentication process 11 and the virtual system operation state management process 12 will be described later in detail.

The client apparatus 80 in FIG. 1 is, for example, a personal computer. The client apparatus 80 includes a CPU, a memory, a communication interface unit, a display device, and an input unit, for example. The client apparatus 80 transmits an access request to the virtual systems vs1 to vs4 from which the client apparatus 80 receives an information processing service. Although a single client apparatus 80 is depicted in the example of FIG. 1, the number of client apparatuses may be two or more.

FIG. 2 is a diagram illustrating an example of virtual servers which configure the virtual systems vs1 to vs4 described above with reference to FIG. 1. FIG. 2 illustrates, as examples, virtual servers vm1 to vm3 which configure the virtual system vs1 running on the first server 30a in FIG. 1.

In the example of FIG. 2, the virtual system vs1 is configured of the three virtual servers vm1 to vm3. The virtual server vm1 corresponds to a web (WEB) server, the virtual server vm2 corresponds to an application (AP) server, and the virtual server vm3 corresponds to a DB server. The virtual servers vm1 to vm3 are connected to the client apparatus 80 and the authentication server 10, which are depicted in FIG. 1, via the communication line 50 such as the Internet.

Although each of the WEB server, the AP server, and the DB server corresponds to a single virtual server in the virtual system vs1 depicted in FIG. 2, the embodiments are not limited to this example. For example, two virtual servers (the WEB server and the AP server, for example) may correspond to a single virtual server. Similarly, the three virtual servers (the WEB server, the AP server, and the DB server) may correspond to a single virtual server.

As described above, a plurality of virtual systems are running in the environment depicted in FIG. 1 and the authentication server 10 collectively manages users who use the plurality of virtual systems. The authentication server 10 performs the user authentication processing for the users who use the information processing service provided by the virtual system. Then, users who are successfully authenticated may use the information processing service.

For example, the client apparatus 80 in FIG. 1 accesses, by designating a uniform resource locator (URL), the WEB server vm1 in the virtual system vs1, for example, which provides an information processing service to be used by the client apparatus 80. Then, the client apparatus 80 downloads a log-in screen from the WEB server vm1 and displays, via a web browser or the like, the log-in screen on the display device included in the client apparatus 80. When a user inputs a user identification (ID) and a password to the log-in screen, the client apparatus 80 transmits the user ID and the password to the authentication server 10. The authentication server 10 cross-checks the user ID and the password with user information with reference to the user authentication DB 13 to perform the user authentication processing. If the user ID and the password match the user information, then the authentication server 10 permits the user to use the information processing service provided by the virtual system vs1.

When no user uses the information processing service provided by a virtual system of the virtual systems vs1 to vs4, the virtual system may not be activated. Thus, it is possible to suppress a burden on the CPUs, usage of the memories, and power consumption of a physical server (the first server 30a or the second server 30b) by stopping the respective virtual servers (virtual servers vm1 to vm3, for example) which configure the virtual system providing the information processing service used by no user. For example, the authentication server 10 may stop all the virtual servers which configure the virtual system providing the information processing service used by no user, and the authentication server 10 may activate the virtual servers when a new access request to the information processing service is made.

However, in the case of providing the WEB server in each virtual system, if all the virtual servers which configure a virtual system are stopped, the WEB server vm1, for example, for accepting a user authentication is also brought into the stopped state. Therefore, the virtual system does not detect a new access request from the client apparatus 80. For this reason, the virtual servers vm2 and vm3, for example, other than the WEB server are controlled to be brought into the stopped state when no user uses the information processing service, and the WEB server vm1 is maintained in the operating state. When the WEB server vm1 detects an access request from the client apparatus 80, then the virtual servers vm2 and vm3 other than the WEB server are activated.

Since the WEB server is provided in each virtual system as described above, the user may easily access each virtual system. In addition, since the authentication server 10 is commonly used by the respective virtual systems, several thousands of users may be authenticated at a high speed.

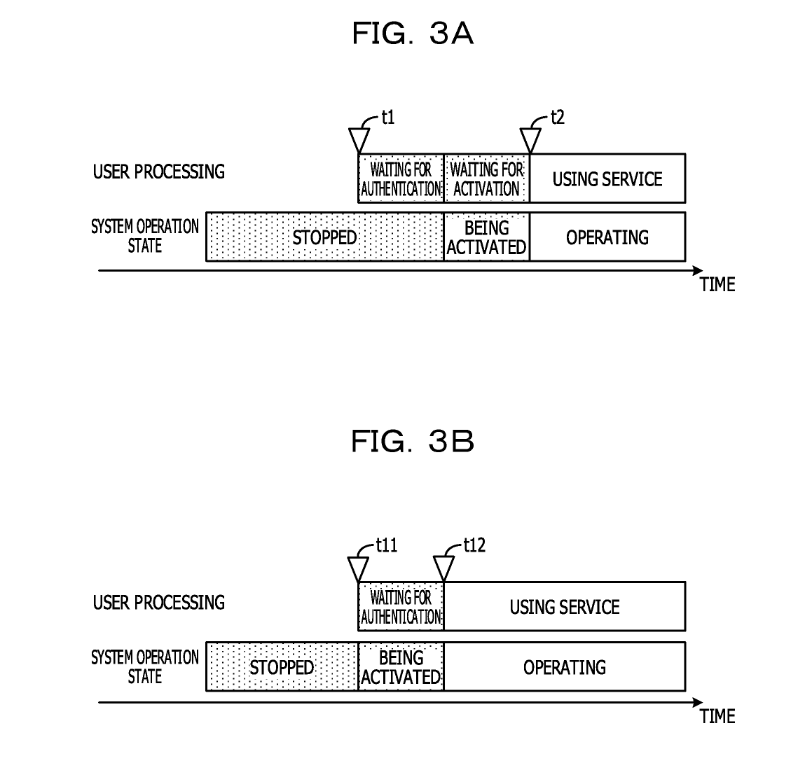

FIGS. 3A and 3B are diagrams illustrating system activation processing when an access request from the client apparatus 80 is newly detected. The examples of FIGS. 3A and 3B are under a condition that the virtual servers vm2 and vm3, for example, other than the WEB server are in the stopped state.

FIG. 3A illustrates processing of activating the virtual servers other than the WEB server after a user is successfully authenticated. Specifically, the authentication server 10 performs the user authentication processing in response to a new access request received at a time t1 from the user, and if the user authentication is successfully made, activation of the virtual servers other than the WEB server is started. Therefore, the user who is successfully authenticated waits until a system activation completion time t2 in order to use the information processing service.

FIG. 3B illustrates processing of activating the virtual servers other than the WEB server in parallel with the occurrence of the user authentication processing according to the present embodiment. Specifically, the processing of activating the virtual servers other than the WEB server is started at the same time as the user authentication processing performed by the authentication server 10 in response to the new access request received at a time t11 from the user. In the example of FIG. 3B, the user authentication processing and the system activation processing are performed in parallel, and therefore, the user who is successfully authenticated may start the usage of the information processing service at a time t12 after waiting for a short time.

Since the user authentication processing and the system activation processing are performed in parallel in the example of FIG. 3B, the system activation processing is performed even in a case where the user authentication fails. That is, the system activation processing also occurs in response to an access request from an unauthorized user who fails to be authenticated. Therefore, the processing of activating the virtual server repeatedly occurs when the unauthorized user repeatedly requests an access, which is inefficient.

Thus, the authentication server 10 (activation management apparatus) according to the present embodiment starts the user authentication processing in response to an access request from the client apparatus 80 and provides an instruction for starting activation of the virtual servers (management target servers) as targets of the access request, and in a case where the access request from the client apparatus 80 is not permitted as a result of the user authentication processing, the authentication server 10 provides an instruction for controlling the activated virtual servers to be brought into a temporarily stopped state. If another request for the access to the virtual servers, which is generated after the control of the virtual servers to be brought into the temporarily stopped state, is permitted, then the authentication server 10 provides an instruction for releasing the temporarily stopped state of the virtual servers.

That is, when a new access request is detected, the authentication server 10 starts the activation of the virtual servers, which configure the virtual system and are in the stopped state, in parallel with the user authentication processing. By performing the user authentication processing and the system activation processing in parallel, the waiting time until the user starts to use an information processing service is shortened.

If the user authentication is failed, then the authentication server 10 according to the present embodiment shifts the virtual servers other than the WEB server in the activated virtual system to the temporarily stopped state. Therefore, since the virtual servers are controlled to be brought into the temporarily stopped state even when the system activation processing is performed in response to an access request from a user who fails to be authenticated, it is possible to suppress the usage of the resources in the CPU and the memory as compared with the case where the system is in the operating state.

If the user authentication is successfully made as a result of the user authentication processing after the shift of the servers other than the WEB server to the temporarily stopped state, then the authentication server 10 according to the present embodiment provides an instruction for releasing the temporarily stopped state. Since the servers in the temporarily stopped state may recover from the temporarily stopped state to the operating state in a short time, an authorized user may start the usage of the information processing service after a short waiting time. If the user authentication fails, then the temporarily stopped state is not released. Therefore, since the servers are maintained in the temporarily stopped state even when there are a lot of access requests from an unauthorized user, it is possible to avoid repetition of unneeded activation processing.

In the composite environment as depicted in FIG. 1, in which a plurality of information processing services are provided, the authentication server 10, activation of which is managed separately from the systems that provide the information processing services, collectively manages users of the plurality of systems. In the systems configured as described above, the authentication server 10 may suppress the usage of the resources by managing activation and stopping of the respective servers which configure the systems, in accordance with the usage states of the respective information processing services. In the case of providing the plurality of information processing services, the usage states of the information processing services differ in accordance with the time of day. Therefore, it is possible to effectively suppress the usage of the resources by stopping (temporarily stopping) a part of the plurality of systems in accordance with the usage states of the information processing services.

As described above, the authentication server 10 according to the present embodiment shortens the waiting time until the user starts to use an information processing service while suppressing the usage of the resources by activating and stopping the systems in accordance with the usage states of the information processing services, and thus maintains a user's convenience.

The present embodiment will be described as a case where the authentication server 10 (activation management apparatus) manages operation states of virtual servers as management target servers. However, the authentication server 10 according to the present embodiment is also effective in the case of managing operation states of physical servers as management target servers. In such a case, the system is configured of a plurality of physical servers. In response to an access request from the client apparatus 80, the authentication server 10 starts the user authentication processing and provides an instruction for starting activation of the physical server to be accessed by the access request. If the access request of the user input from the client apparatus 80 is not permitted as a result of the user authentication processing, the authentication server 10 provides an instruction for controlling the activated physical server to be brought into the temporarily stopped state.

With such a configuration, the user may start the usage of the information processing service after a short waiting time without caring about the time for waiting for the activation of the system. In addition, the authentication server 10 may suppress the usage of the resources, such as electrical power consumed by the physical servers, by activating and stopping the physical servers in accordance with the usage states of the information processing services while shortening the user waiting time.

Next, a description will be given of a hardware configuration and a functional configuration of the authentication server 10 according to the present embodiment.

FIG. 4 is a diagram illustrating a hardware configuration of the authentication server 10 according to the present embodiment as depicted in FIG. 1. The authentication server 10 depicted in FIG. 4 includes a CPU 101 (processing unit), a memory 102 including a random access memory (RAM) 201 and a nonvolatile memory 202, and a communication interface unit 103 (communication unit). The respective components are connected to one another via a bus 104. The first server 30a, the second server 30b, and the virtual-environment management server 40 depicted in FIG. 1 have similar hardware configurations.

The CPU 101 is connected to the memory 102 and the like via the bus 104 to perform overall control on the authentication server 10. The RAM 201 in the memory 102 stores therein data processed by the CPU 101, and the like. The nonvolatile memory 202 in the memory 102 includes a region (not illustrated) on which a program of an operating system (OS) executed by the CPU 101 is stored and a region 210 on which an activation management program according to the present embodiment is stored.

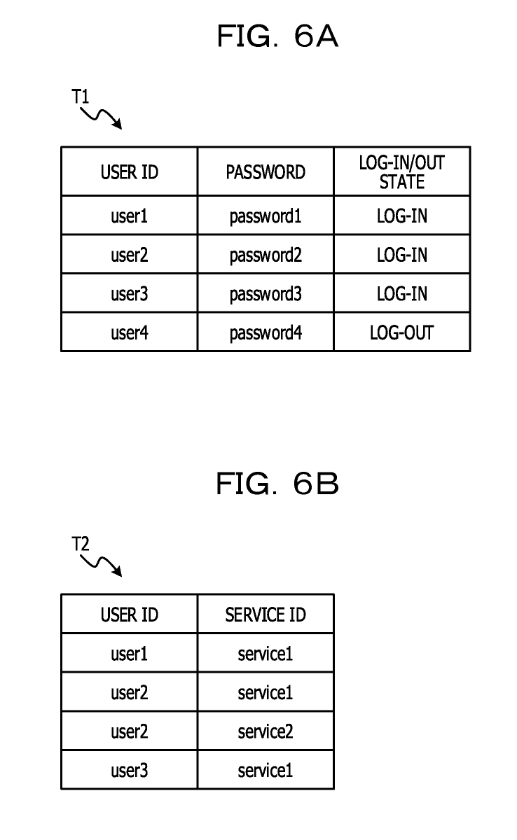

The nonvolatile memory 202 includes a storage device (not illustrated) which stores therein the user authentication DB 13 and the virtual system management DB 14. Information stored on the user authentication DB 13 and the virtual system management DB 14 will be described later in detail with reference to FIGS. 6A, 6B, 7A, 7B, and 8. The nonvolatile memory 202 is configured of a hard disk drive (HDD), a nonvolatile semiconductor memory, or the like.

The virtual system operation state management process 12 according to the present embodiment as depicted in FIG. 1 is realized when the CPU 101 executes the activation management program stored in the region 210. The communication interface unit 103 controls data exchange with the client apparatus 80, the first server 30a, the second server 30b, the virtual-environment management server 40, and the like via the communication line 50.

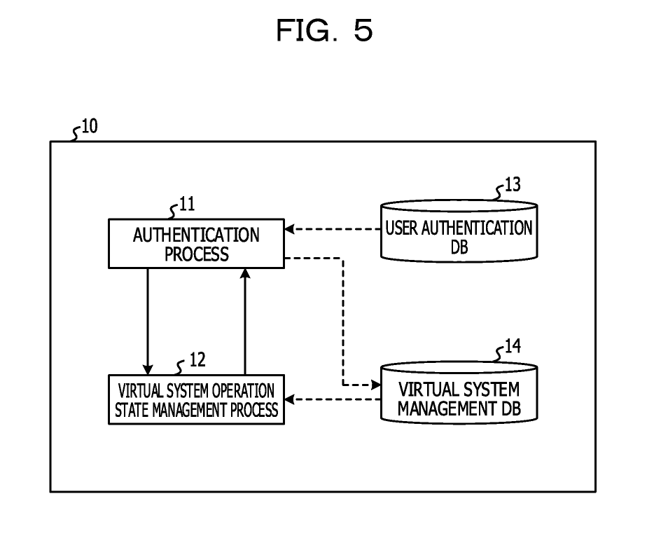

FIG. 5 is a diagram illustrating a functional configuration of the authentication server 10 according to the present embodiment as depicted in FIG. 1. The virtual system operation state management process 12 includes the authentication process 11 and the virtual system operation state management process 12.

The authentication process 11 performs user authentication processing for a plurality of systems with reference to the user authentication DB 13 (FIGS. 1 and 4). The authentication process 11 cross-checks a user ID and a password with user information stored on the user authentication DB 13. If the user ID and the password match the user information, the authentication process 11 permits the access request and the information processing service is provided. If the user authentication is successfully made, the authentication process 11 updates the user information stored in the virtual system management DB 14 (FIGS. 1 and 4).

The virtual system operation state management process 12 detects usage states of the information processing services with reference to the virtual system management DB 14 to control activation and stopping of the respective virtual servers which configure the systems providing the information processing services. The virtual system operation state management process 12 manages, via the virtual-environment management server 40, the activation and the stopping of the respective virtual servers vm2 and vm3, for example, which configure the virtual systems vs1 to vs4 running on the first server 30a and the second server 30b depicted in FIG. 1.

Although the authentication server 10 according to the present embodiment includes the user authentication DB 13 and the virtual system management DB 14, the embodiments are not limited thereto. Another server which the authentication server 10 accesses may include the user authentication DB 13 and the virtual system management DB 14. Alternately, the authentication server 10 may acquire similar information to the information included in the user authentication DB 13 and the virtual system management DB 14 from the virtual-environment management server 40 depicted in FIG. 1.

The user authentication DB 13 includes a user table region T1. The virtual system management DB 14 includes a currently-used-service table region T2, a service table region T3, a virtual system operation state table region T4, and a virtual machine (VM) table region T5. Here, configurations of the respective table regions T1 to T5 will be described.

FIG. 6A is a diagram illustrating a configuration of the user table region T1 stored on the user authentication DB 13. FIG. 6B is a diagram illustrating a configuration of the currently-used-service table region T2 stored on the virtual system management DB 14.

FIG. 6A illustrates the user table region T1. The user table region T1 is a region on which a preset user ID, a preset password, and a log-in/out state are stored. Specifically, according to the example of the user table region T1 illustrated in FIG. 6A, a password corresponding to the user ID “user1” is “password1”. Since the corresponding user currently logs into one of the management target systems, the user is in a “log-in” state. Similarly, a password corresponding to the user ID “user4” is “password4”, and the corresponding user is in a “log-out” state.

FIG. 6B illustrates the currently-used-service table region T2. The currently-used-service table region T2 is a region for storing information on the services currently used by users. The currently-used-service table region T2 includes a user ID and a service ID. The service ID is an ID of a service provided by a system which is currently logged-in and used by a user indicated by the user ID. Specifically, according to the example of the currently-used-service table region T2 illustrated in FIG. 6B, a user indicated by the user ID “user1” is using an information processing service indicated by the service ID “service1”, a user indicated by the user ID “user2” is using two information processing services indicated by the service IDs “service1” and “service2”.

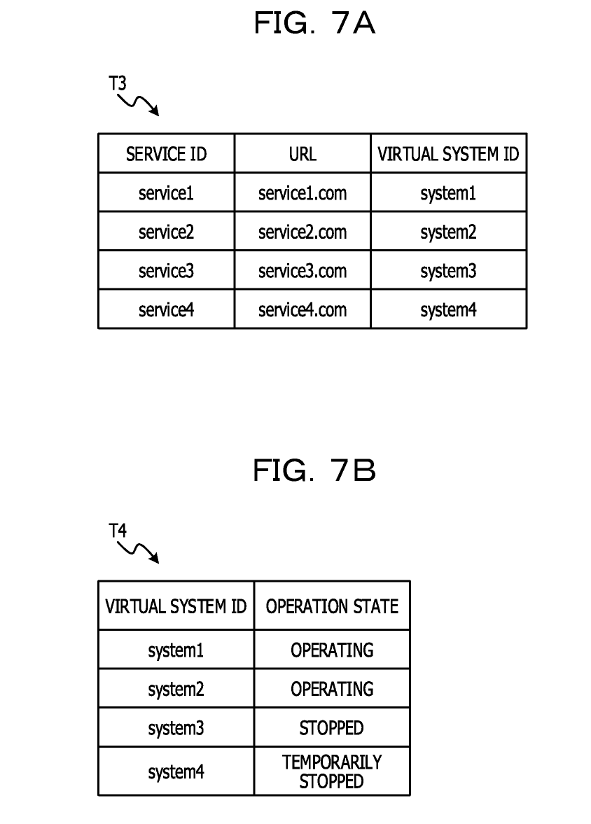

FIG. 7A is a diagram illustrating a configuration of the service table region T3 stored on the virtual system management DB 14. FIG. 7B is a diagram illustrating a configuration of the virtual system operation state table region T4 stored on the virtual system management DB 14.

FIG. 7A illustrates the service table region T3. The service table region T3 is a region for storing information on a corresponding URL and a virtual system ID for each service ID for identifying an information processing service. The service table region T3 includes information on the service ID, the URL, and the virtual system ID. The URL is a URL to be accessed by an access request. The virtual system ID is information for identifying a virtual system providing the information processing service indicated by the service ID.

Specifically, according to the example of the service table region T3 illustrated in FIG. 7A, the client apparatus 80 requests an access to a virtual system indicated by the virtual system ID “system1” that provides the information processing service indicated by the service ID “service1” by accessing the URL “service1.com”. Similarly, the client apparatus 80 requests an access to a virtual system indicated by the virtual system ID “system2” that provides the information processing service indicated by the service ID “service2” by accessing the URL “service2.com”.

FIG. 7B illustrates the virtual system operation state table region T4. The virtual system operation state table region T4 is a region for storing an operation state for each virtual system ID identifying a virtual system. The operation state is a state of the virtual servers other than the WEB server from among the virtual servers which configure the virtual system.

Specifically, according to the example of the virtual system operation state table region T4 illustrated in FIG. 7B, the operation state of the servers (the AP server and the DB server, for example) other than the WEB server, which configure the virtual system indicated by the virtual system ID “system1”, is an “operating” state. The operation state of the servers other than the WEB server, which configure a virtual system indicated by the virtual system ID “system3”, is a “stopped” state, and the operation state of the servers other than the WEB server, which configure a virtual system indicated by the virtual system ID “system4”, is a “temporarily stopped” state.

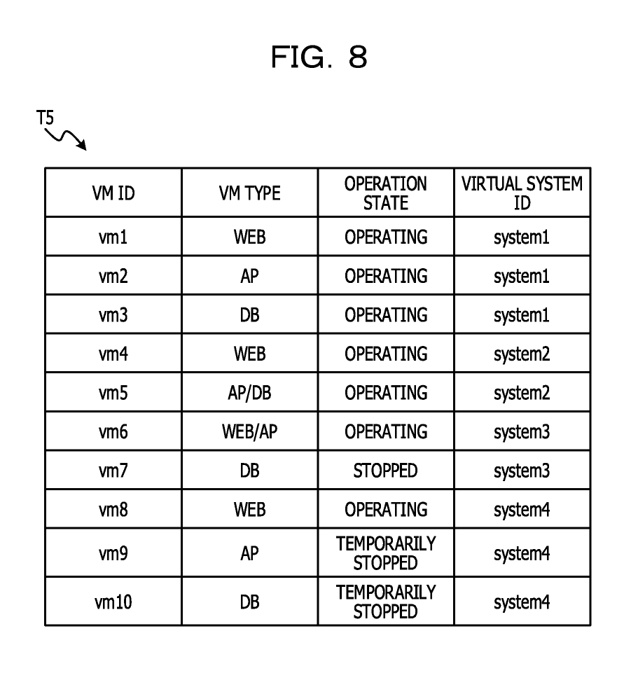

FIG. 8 is a diagram illustrating a configuration of the VM table region T5 stored on the virtual system management DB 14. The VM table region T5 is a region including virtual server information for each VM ID identifying each of the virtual servers. The VM table region T5 includes information on the VM ID, a VM type, the operation state, and the virtual system ID. The VM type is one or more server types of the corresponding virtual server. The server types include a WEB server “WEB”, an AP server “AP”, and a DB server “DB”. The operation state is a state of the virtual server indicated by the VM ID. The virtual system ID is an ID of the virtual system including the virtual server indicated by the VM ID.

Specifically, according to the example of the VM table region T5 illustrated in FIG. 8, the virtual server indicated by the VM ID “vm1” is a WEB server included in the virtual system indicated by the virtual system ID “system1”, and is in the “operating” state. The virtual server indicated by the VM ID “vm2” and the virtual server indicated by the VM ID “vm3” are also included in the virtual system indicated by the virtual system ID “system1”. The virtual server indicated by the VM ID “vm2” is an AP server, the virtual server indicated by the VM ID “vm3” is a DB server, and both the virtual servers are in the “operating” state.

Virtual servers indicated by a VM ID “vm4” and a VM ID “vm5” are included in the virtual system indicated by the virtual system ID “system2”. The virtual server indicated by the VM ID “vm4” is a WEB server, the virtual server indicated by the VM ID “vm5” is an AP server and a DB server, and both the virtual servers are in the “operating” state. That is, the virtual system indicated by the virtual system ID “system2” is configured of the two virtual servers.

Virtual servers indicated by a VM ID “vm6” and a VM ID “vm7” are included in the virtual system indicated by the virtual system ID “system3”. The virtual server indicated by the VM ID “vm6” is a WEB server and an AP server and is in the “operating” state. The virtual server indicated by the VM ID “vm7” is a DB server and is in the “stopped” state. That is, the virtual system indicated by the virtual system ID “system3” is configured of the two virtual servers similarly to the virtual system indicated by the virtual system ID “system2”. However, the virtual system indicated by the virtual system ID “system3” is different from the virtual system indicated by the virtual system ID “system2” in that the WEB server and the AP server operate on a single virtual server.

Virtual servers indicated by a VM ID “vm8”, a VM ID “vm9”, and a VM ID “vm10” are included in the virtual system indicated by the virtual system ID “system4”. The virtual server indicated by the VM ID “vm8” is a WEB server and is in the “operating” state. The virtual server indicated by the VM ID “vm9” is an AP server, the virtual server indicated by the VM ID “vm10” is a DB server, and both the virtual servers are in the “temporarily stopped” state.

Next, a description will be given of the user activation management processing according to the present embodiment with reference to flowcharts.

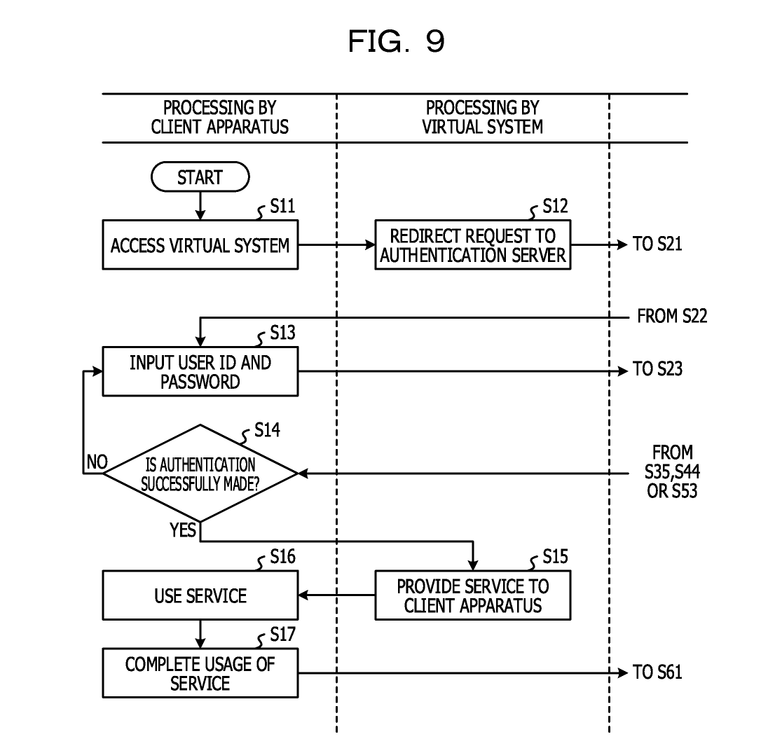

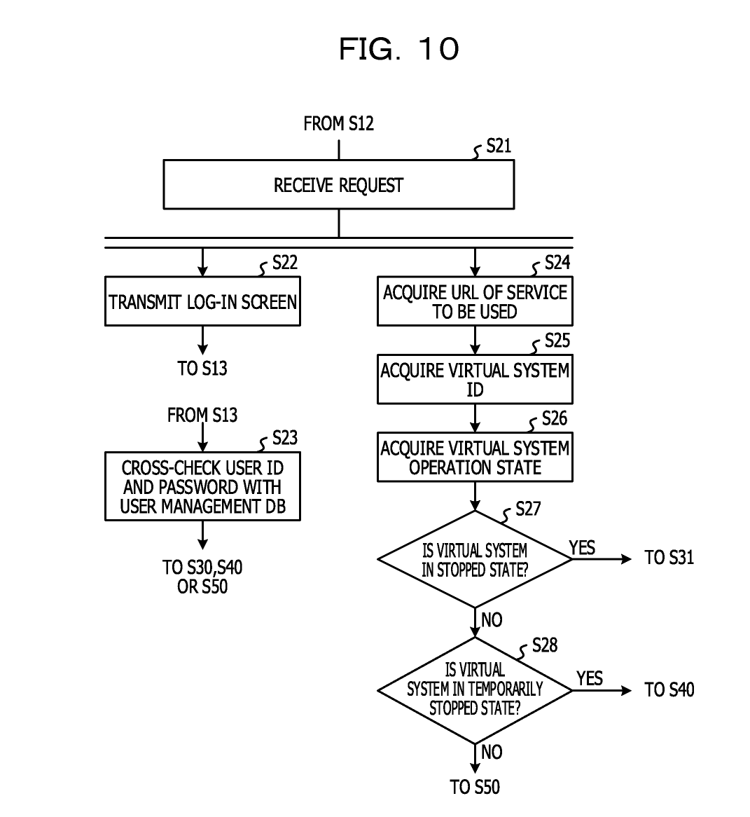

FIG. 9 is a flowchart illustrating processing performed by the client apparatus 80 and the virtual systems vs1 to vs4 according to the present embodiment. In response to a user operation, the client apparatus 80 transmits an access request to a URL of one of the virtual systems vs1 to vs4, from which an information processing service is to be received (S11). According to the present embodiment, the WEB server from among the servers which configure the system is in the operating state, and therefore, the WEB server is able to receive the access request from the client apparatus 80. Upon detecting the occurrence of the access request, the WEB server in the requested virtual system redirects (transfers) the request to the authentication server 10 (S12). Thereafter, the processing proceeds to S21 in FIG. 10.

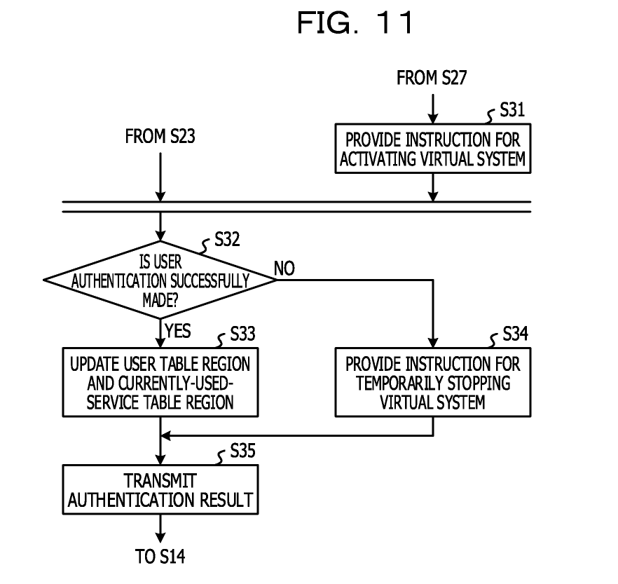

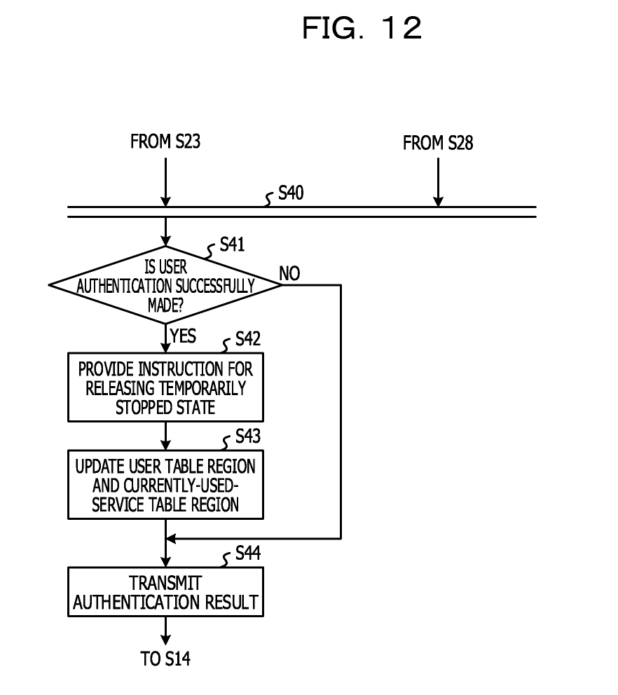

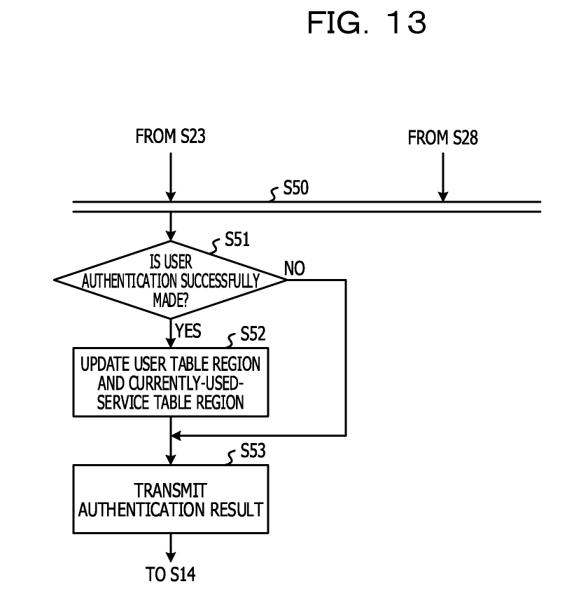

Upon receiving the request (S21 in FIG. 10), the authentication process 11 in the authentication server 10 causes the client apparatus 80 to download a log-in screen in response to the request (S22). The client apparatus 80 displays the received log-in screen to prompt the user to input a user ID and a password, and transmits the user ID and the password to the authentication server 10 (S13). Thereafter, the processing proceeds to S23 in FIG. 10. The authentication process 11 in the authentication server 10 performs the user authentication processing based on the user ID and the password (S23), and transmits a result of the user authentication to the client apparatus 80 (S35 in FIG. 11, S44 in FIG. 12, or S53 in FIG. 13). If the user authentication fails (NO in S14), then the client apparatus 80 receives a user ID and a password input again (S13).

If the user authentication is successfully made (YES in S14), then the authentication process 11 transmits an authentication Cookie, for example, to the client apparatus 80. The client apparatus 80 is able to certify that the user is authorized by transmitting the authentication Cookie to the virtual system to which the access request are transmitted. The requested virtual system permits the access request from the authorized user and provides the information processing service to the client apparatus 80 (S15).

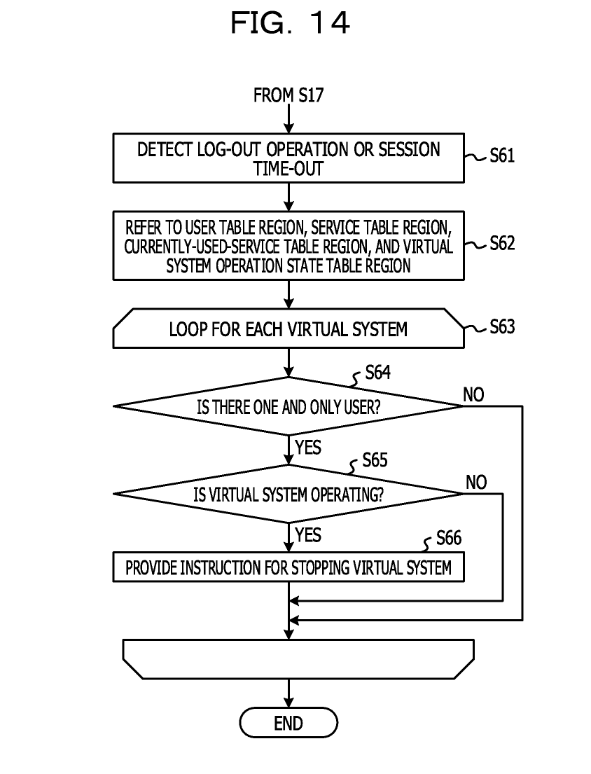

Then, the client apparatus 80 uses the information processing service provided by the requested virtual system (S16). For example, the client apparatus 80 outputs, to the requested virtual system, a request for transmitting files including images and information, and downloads the desired files from the requested virtual system. Then, the client apparatus 80 completes the usage of the information processing service in response to a log-out operation from the user or an occurrence of a time-out which is caused because no instruction is provided from the client apparatus 80 for a predetermined period of time (S17). At this time, the client apparatus 80 provides information indicating that the client apparatus 80 will complete the usage of the information processing service to the authentication server 10 and the requested virtual system. Thereafter, the processing proceeds to S61 in FIG. 14.

FIG. 10 is a flowchart illustrating the activation management processing performed by the authentication server 10 corresponding to the flowchart in FIG. 9. Upon receiving the access request from the client apparatus 80 (S21), the authentication process 11 in the authentication server 10 transmits the log-in screen to the client apparatus 80 (S22). Thereafter, the processing proceeds to S13 in FIG. 9. As described above with reference to the flowchart in FIG. 9, upon receiving the log-in screen, the client apparatus 80 prompts the user to input the user ID and the password, and transmits the user ID and the password to the authentication server 10 (S13 in FIG. 9). Then, the authentication process 11 are cross-checks the received user ID and the password with the user table region T1 in the user management DB (S23), and it is determined whether or not the user is successfully authenticated in accordance with whether or not the user ID and the password coincide with information in the user table region T1 (S32 in FIG. 11, S41 in FIG. 12, or S51 in FIG. 13).

In parallel with the processing in S22 and S23, the virtual system operation state management process 12 in the authentication server 10 provides an instruction for performing the system activation processing. Specifically, upon receiving the access request from the client apparatus 80 (S21), the virtual system operation state management process 12 acquires, based on the received access request, a URL of the information processing service to be used (S24). Then, the virtual system operation state management process 12 searches the service table region T3 by the acquired URL to acquire a virtual system ID corresponding to the URL (S25). The virtual system operation state management process 12 searches the virtual system operation state table region T4 by the virtual system ID to acquire the operation state of the virtual system (the virtual servers other than the WEB server) indicated by the virtual system ID (S26).

According to the service table region T3 illustrated in FIG. 7A and the virtual system operation state table region T4 illustrated in FIG. 7B described above, in a case where the URL is “service1.com”, for example, the virtual system operation state management process 12 searches the service table region T3 by the URL “service1.com” to acquire the virtual system ID “system1” (S25). Then, the virtual system operation state management process 12 searches the virtual system operation state table region T4 by the acquired virtual system ID “system1” to acquire the operation state “operating” of the corresponding virtual system (S26). In a case where the URL is “service2.com”, for example, the virtual system operation state management process 12 searches the service table region T3 by the URL “service2.com” to acquire the virtual system ID “system2” (S25). Then, the virtual system operation state management process 12 searches the virtual system operation state table region T4 by the acquired virtual system ID “system2” to acquire the operation state “operating” of the corresponding virtual system (S26).

In a case where the URL is “service3.com”, for example, the virtual system operation state management process 12 searches the service table region T3 by the URL “service3.com” to acquire the virtual system ID “system3” (S25). Then, the virtual system operation state management process 12 searches the virtual system operation state table region T4 by the acquired virtual system ID “system3” to acquire the operation state “stopped” of the corresponding virtual system (S26). In a case where the URL is “service4.com”, for example, the virtual system operation state management process 12 searches the service table region T3 by the URL “service4.com” to acquire the virtual system ID “system4” (S25). Then, the virtual system operation state management process 12 searches the virtual system operation state table region T4 by the acquired virtual system ID “system4” to acquire the operation state “temporarily stopped” of the corresponding virtual system (S26).

If the acquired operation state of the virtual system is stopped state (YES in S27), then the processing proceeds to S31 in FIG. 11, in which the virtual system operation state management process 12 outputs an instruction for activating the target virtual system (the virtual servers other than the WEB server). The following processing will be described with reference to the flowchart in FIG. 11. FIG. 11 illustrates the processing performed when an access to a virtual system indicated by the virtual system ID “system3” is requested in the case of FIG. 7B.

If the acquired operation state of the virtual system is the temporarily stopped state (NO in S27, YES in S28), the processing proceeds to S40 in FIG. 12. If the user authentication is successfully made (YES in S41 in FIG. 12), then an instruction for releasing the temporarily stopped state of the target virtual system (the virtual servers other than the WEB server) is provided (S42). Processing in S40 and the following processing will be described with reference to the flowchart in FIG. 12. FIG. 12 illustrates the processing performed when an access to the virtual system indicated by the virtual system ID “system4” is requested in the case of FIG. 7B.

If the acquired operation state of the virtual system is the operating state (NO in S27, NO in S28), then the processing proceeds to S50 in FIG. 13, in which the virtual system operation state management process 12 provides neither the instruction for activation nor the instruction for release from the temporarily stopped state. The processing in S50 and the following processing will be described with reference to the flowchart in FIG. 13. FIG. 13 illustrates the processing performed when an access to the virtual systems indicated by the virtual system ID “system1” or “system2” is requested in the case of FIG. 7B.

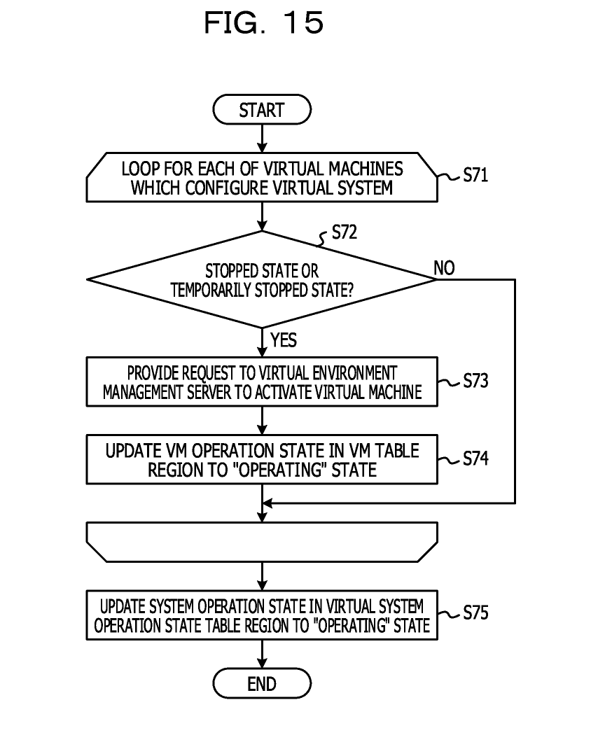

FIG. 11 is a flowchart illustrating the activation management processing in the case where the virtual servers are in the stopped state. As described above with reference to the flowchart in FIG. 10, if the access to the virtual system indicated by the virtual system ID “system3” is requested in the case of FIG. 7B, the virtual system is in the stopped state (YES in S27 in FIG. 10), and therefore, the virtual system operation state management process 12 outputs the instruction for activating the virtual system (S31). S31 will be described later in detail with reference to the flowchart in FIG. 15.

As described above with reference to the flowchart in FIG. 10, the virtual system operation state management process 12 cross-checks the received user ID and the password with the user table region T1 (S23 in FIG. 10) in parallel with the processing of activating the virtual system. If the user authentication is successfully made (YES in S32), the virtual system operation state management process 12 updates the user table region T1 and the currently-used-service table region T2 (S33).

An example in which the user indicated by the user ID “user4” requests an access to the virtual system indicated by the virtual system ID “system3” and the user authentication is successfully made (YES in S32) will be described. In such a case, the authentication server 10 updates the log-in state of the user ID “user4” to “log-in” in the user table region T1 in FIG. 6A, and adds information of the user ID “user4” and a currently-used-service ID “service3” to the currently-used-service table region T2 in FIG. 6B (S33).

As described above, the authentication server 10 according to the present embodiment performs the user authentication processing and the system activation processing in parallel. With such a configuration, it is possible to shorten the waiting time until the authorized user starts to use the information processing service. Therefore, the authorized user may start the usage of the information processing service after a short waiting time without caring about the time for waiting for the activation of the system even in the case where the system is controlled to stop since no user uses the information processing service.

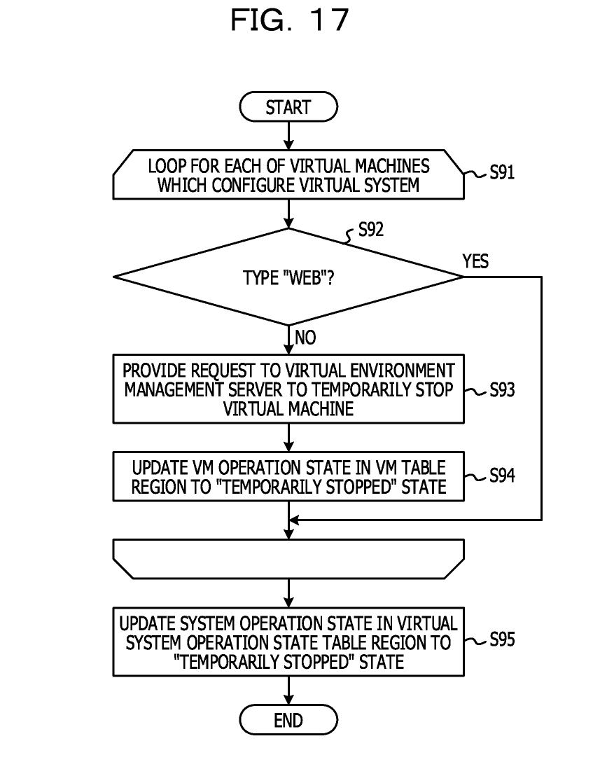

If the user authentication fails (NO in S32), the virtual system operation state management process 12 outputs an instruction for controlling the virtual servers, the activation of which is instructed, to be brought into the temporarily stopped state after the activation (S34). S34 will be described later in detail with reference to the flowchart in FIG. 17. After S33 or S34, authentication process 11 outputs the result of the user authentication to the client apparatus 80 (S35). Thereafter, the processing proceeds to S14 in FIG. 9.

By controlling the system to be brought into the temporarily stopped state in a case where the user authentication fails, even if the system activation processing is performed in response to the access request from the user who fails to be authenticated, it is possible to suppress the usage of the resources in the CPU and the memory as compared with the case where the system is maintained in the operating state. In addition, since the temporarily stopped state is maintained without being released in a case where access requests from unauthorized users are repeated, it is possible to avoid an occurrence of unneeded activation processing.

FIG. 12 is a flowchart illustrating the activation management processing in a case where the virtual servers are in the temporarily stopped state. If the virtual system is in the temporarily stopped state (YES in S28 in FIG. 10), the virtual system operation state management process 12 determines whether or not the user authentication is successfully made (S41). If the user authentication is successfully made (YES in S41), then the virtual system operation state management process 12 provides an instruction for releasing the temporarily stopped state of the target virtual system (the virtual servers other than the WEB server) (S42). S42 will be described later in detail with reference to the flowchart in FIG. 15.

As described above with reference to the flowchart in FIG. 10, if the access to the virtual system indicated by the virtual system ID “system4” is requested in the case of FIG. 7B, the virtual system is in the temporarily stopped state (NO in S27, YES in S28), and therefore, the virtual system operation state management process 12 outputs the instruction for releasing the temporarily stopped state of the virtual system indicated by the virtual system ID “system4” in the case where the user authentication is successfully made. Then, the virtual system operation state management process 12 updates the user table region T1 and the currently-used-service table region T2 (S43). The processing of updating the user table region T1 and the currently-used-service table region T2 performed when the user authentication is successfully made is as described above with reference to FIG. 11.

As described above, in the case where a new access request to a target virtual system, in which the virtual servers are in the temporarily stopped state, is generated and the user authentication is successfully made, the virtual system operation state management process 12 according to the present embodiment provides the instruction for releasing the temporarily stopped state of the virtual servers. Since the virtual servers may recover from the temporarily stopped state to the operating state in a short time, the authorized user may start the usage of the information processing service after a short waiting time.

In contrast, if the user authentication fails (NO in S41), the virtual system operation state management process 12 does not output the instruction for releasing the temporarily stopped state of the virtual servers. As described above, since the temporarily stopped state is maintained in the case where unauthorized users request access, it is possible to avoid an occurrence of unneeded activation processing. After S41 to S43, the virtual system operation state management process 12 outputs the result of the user authentication to the client apparatus 80 (S44). Thereafter, the processing proceeds to S14 in FIG. 9.

FIG. 13 is a flowchart illustrating the activation management processing in a case where the virtual servers other than the WEB server, among the servers included in the target virtual system, are already in the operating state. If the virtual system is in the operating state (NO in S28 in FIG. 10), the virtual system operation state management process 12 determines whether or not the user authentication is successfully made (S51). As described above with reference to the flowchart in FIG. 10, if the access to the virtual system indicated by the virtual system ID “system1” or “system2” is requested in the case of FIG. 7B, the virtual system is in the operating state (NO in S28 in FIG. 10), and therefore, the virtual system operation state management process 12 provides neither the instruction for activation nor the instruction for release from the temporarily stopped state.

If the user authentication is successfully made (YES in S51), the virtual system operation state management process 12 updates the user table region T1 and the currently-used-service table region T2 (S52). The processing of updating the user table region T1 and the currently-used-service table region T2 performed when the user authentication is successfully made is as described above with reference to FIG. 11. If the user authentication fails (NO in S51), the virtual system operation state management process 12 does not update the user table region T1 and the currently-used-service table region T2. After S51 and S52, the virtual system operation state management process 12 outputs the result of the user authentication to the client apparatus 80 (S53). Thereafter, the processing proceeds to S14 in FIG. 9.

FIG. 14 is a flowchart illustrating processing performed by the authentication server 10 after completion of the access of the user to the virtual system. As described above with reference to FIG. 9, the client apparatus 80 completes the usage of the information processing services in response to a log-out operation from the user or an occurrence of a time-out (S17 in FIG. 9), and provides information indicating the completion of the usage of the information processing service to the authentication server 10 and the virtual system. Thereafter, the processing proceeds to S61 in FIG. 14. The flowchart in FIG. 14 illustrates processing in S61 and the following processing.

The virtual system operation state management process 12 detects the log-out of the client apparatus 80 from the information processing service or the session time-out, and acquires the user ID of the user who completes the access (S61). Then, the virtual system operation state management process 12 searches the user table region T1, the currently-used-service table region T2, the service table region T3, and the virtual system operation state table region T4 by the user ID (S62).

The virtual system operation state management process 12 performs, with reference to the currently-used-service table region T2, S64 to S66 for information processing services provided by respective virtual systems logged in by the user indicated by the acquired user ID (S63). The virtual system operation state management process 12 determines, with reference to the currently-used-service table region T2, whether the user indicated by the acquired user ID is the one and only user, that is, whether or not there are other user IDs in the log-in state in the virtual system logged in by the user indicated by the acquired user ID (S64).

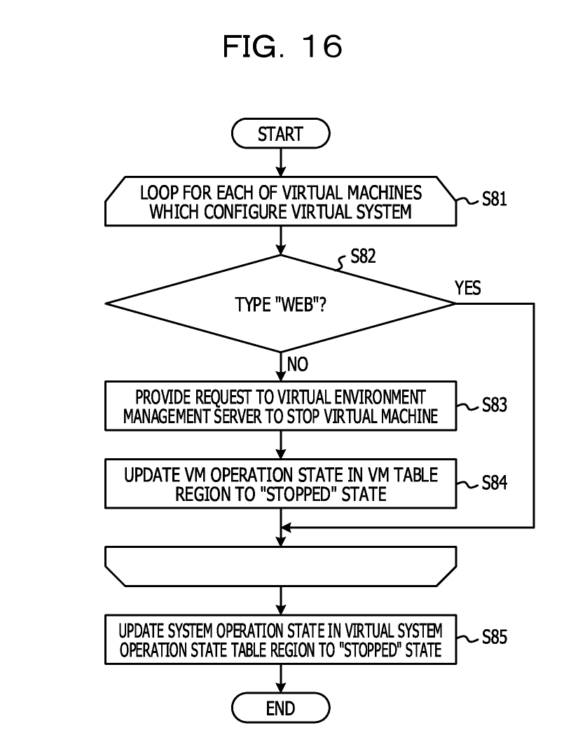

If there is no other user ID (YES in S64), the virtual system operation state management process 12 determines, with reference to the service table region T3, the virtual system operation state table region T4, and the VM table region T5, whether or not the target virtual system is in the operating state (S65). If the target virtual system is in the operating state (YES in S65), the virtual system operation state management process 12 provides an instruction for stopping the target virtual system (S66). S66 will be described later in detail with reference to the flowchart in FIG. 16.

A case where a log-out of the user ID “user1” is detected by the virtual system operation state management process 12 in the case of the currently-used-service table region T2 in FIG. 6B will be exemplified. The virtual system operation state management process 12 acquires, with reference to the currently-used-service table region T2, the service ID “service1” of the virtual system logged in by the user ID “user1” (S63). Then, the virtual system operation state management process 12 detects other user IDs “user2” and “user3” which are currently in the log-in state for the information processing service indicated by the service ID “service1”. In this case, since other user IDs “user2” and “user3” are present (NO in S64), the virtual system operation state management process 12 does not provide the instruction for stopping the virtual system.

Another case where a log-out of the user ID “user2” is detected by the virtual system operation state management process 12 in the case of the currently-used-service table region T2 in FIG. 6B will be exemplified. The virtual system operation state management process 12 acquires, with reference to the currently-used-service table region T2, the service IDs “service1” and “service2” of the virtual systems logged in by the user ID “user2” (S63). Since there are other user IDs “user1” and “user3” which are currently in the log-in state for the information processing service indicated by the service ID “service1” as described above (NO in S64), the virtual system operation state management process 12 does not provide the instruction for stopping the virtual system.

In contrast, there is no other user ID which is currently in the log-in state for the information processing service indicated by the service ID “service2” (YES in S64). Therefore, the virtual system operation state management process 12 acquires, with reference to the service table region T3 in FIG. 7A and the virtual system operation state table region T4 in FIG. 7B, the operation state “operating” corresponding to the virtual system ID “system2” corresponding to the service ID “service2” (S65). Since the virtual system indicated by the virtual system ID “system2” is in the operating state, the virtual system operation state management process 12 provides the instruction for stopping the virtual system indicated by the virtual system ID “system2” (S66).

As described above, if the virtual system operation state management process 12 detects the log-out of the user or the session time-out, and other users do not log into the target virtual system, the virtual system operation state management process 12 controls the virtual system to be brought into the stopped state. With such a configuration, the virtual system that provides the information processing service is controlled to be brought into the stopped state except for the virtual server serving as the WEB server in the case where no user uses the information processing service. Thus, it is possible to save the usage of the resources.

FIG. 15 is a flowchart illustrating processing of activating the virtual system and releasing the temporary stop of the virtual system performed by the authentication server 10. The flowchart in FIG. 15 corresponds to the instruction for the activation in S31 in FIG. 11 and the instruction for releasing the temporarily stopped state in S42 in FIG. 12.

The virtual system operation state management process 12 refers to the VM table region T5 to perform processing in S72 to S74 for each of the virtual servers other than the WEB server from among the virtual servers which configure the target virtual system for which the instruction for the activation or the instruction for releasing the temporarily stopped state is provided (S71).

The virtual system operation state management process 12 performs the processing in S73 and S74 in the case where the target virtual server is in the stopped state or in the temporarily stopped state (YES in S72) with reference to the virtual system operation state table region T4. First, the virtual system operation state management process 12 activates the target virtual server (S73). Specifically, if the virtual server is in the stopped state, then the virtual system operation state management process 12 outputs an instruction for activating the virtual server to the virtual-environment management server 40. The virtual-environment management server 40 acquires information on the target virtual server on the basis of configuration information of the virtual server in response to the instruction for the activation, and controls the activation of the virtual server via the communication line 60. If the virtual server is in the temporarily stopped state, then the virtual system operation state management process 12 outputs an instruction for releasing the temporarily stopped state of the virtual server to the virtual-environment management server 40. The virtual-environment management server 40 acquires the information of the target virtual server on the basis of the configuration information of the virtual server in response to the instruction for releasing the temporarily stopped state, and releases the temporarily stopped state of the virtual server via the communication line 60.

Then, the virtual system operation state management process 12 updates the operation state of the target virtual server in the VM table region T5 from the stopped state or the temporarily stopped state to the operating state (S74). After the processing in S72 to S74 is performed for the target virtual servers, the virtual system operation state management process 12 updates the operation state of the target virtual system in the virtual system operation state table region T4 from the stopped state or the temporarily stopped state to the operating state (S75).

A description will be given of a case where an instruction for activating the virtual system indicated by the virtual system ID “system3” is provide. The virtual system operation state management process 12 refers to the VM table region T5 in FIG. 8 to detect the virtual server vm7 which does not correspond to the VM type of “WEB” from among the virtual servers vm6 and vm7 which configure the virtual system indicated by the virtual system ID “system3” (S71). Then, the virtual system operation state management process 12 confirms that the virtual server vm7 is in the stopped state with reference to the virtual system operation state table region T4 in FIG. 7B (YES in S72), and outputs an instruction for activating the virtual server to the virtual-environment management server 40 (S73). Then, the virtual system operation state management process 12 updates the operation state of the virtual server vm7 in the VM table region T5 from the stopped state to the operating state (S74), and also updates the operation state of the virtual system indicated by the virtual system ID “system3” in the virtual system operation state table region T4 from the stopped state to the operating state (S75).

A description will be given of a case where an instruction for releasing the temporarily stopped state of the virtual system indicated by the virtual system ID “system4” is provided. The virtual system operation state management process 12 refers to the VM table region T5 in FIG. 8 to detect the virtual servers vm9 and vm10 which do not correspond to the VM type of “WEB” from among the virtual servers vm8 to vm10 which configure the virtual system indicated by the virtual system ID “system4” (S71). Then, the virtual system operation state management process 12 confirms that the virtual servers vm9 and vm10 are in the temporarily stopped state with reference to the virtual system operation state table region T4 in FIG. 7B (YES in S72), and outputs an instruction for releasing the temporarily stopped state of the virtual servers to the virtual-environment management server 40 (S73). Then, the virtual system operation state management process 12 updates the operation state of the virtual servers vm9 and vm10 in the VM table region T5 from the temporarily stopped state to the operating state (S74), and also updates the operation state of the virtual system indicated by the virtual system ID “system4” in the virtual system operation state table region T4 from the temporarily stopped state to the operating state (S75).

FIG. 16 is a flowchart illustrating processing of stopping the virtual system performed by the authentication server 10. The flowchart in FIG. 16 corresponds to the processing in S66 in the flowchart in FIG. 14. The virtual system operation state management process 12 performs processing in S82 to S84 for each of the virtual servers other than the WEB server from among the virtual servers which configure the virtual system for which the instruction for the stop is provided (S81).

The virtual system operation state management process 12 refers to the VM table region T5 to determine whether or not the target virtual server corresponds to the VM type of “WEB” (S82). The virtual system operation state management process 12 performs the processing in S83 and S84 for each of the virtual servers which do not correspond to the VM type of “WEB” (NO in S82). The virtual system operation state management process 12 outputs an instruction for stopping the virtual server to the virtual-environment management server 40 (S83). Then, the virtual system operation state management process 12 updates the operation state of the virtual server in the VM table region T5 from the operating state to the stopped state (S84).

After the processing in S82 to S84 is performed for the target virtual servers, the virtual system operation state management process 12 updates the operation state of the target virtual system in the virtual system operation state table region T4 from the operating state to the stopped state (S85).

A description will be given of a case where an instruction for stopping the virtual system indicated by the virtual system ID “system2” is provided. The virtual system operation state management process 12 refers to the VM table region T5 in FIG. 8 to detect the virtual server vm5 which does not correspond to the VM type of “WEB” from among the virtual servers vm4 and vm5 which configure the virtual system indicated by the virtual system ID “system2” (S82). Then, the virtual system operation state management process 12 outputs an instruction for stopping the virtual server vm5 to the virtual-environment management server 40 (S83), and updates the operation state of the virtual server vm5 in the VM table region T5 from the operating state to the stopped state (S84).

FIG. 17 is a flowchart illustrating processing of temporarily stopping the virtual system performed by the authentication server 10. The flowchart in FIG. 17 corresponds to the processing in S34 in the flowchart in FIG. 11. The virtual system operation state management process 12 performs processing in S92 to S94 for each of the virtual servers other than the WEB server from among the virtual servers which configure the virtual system for which the instruction for the temporary stop is provided (S91).

The virtual system operation state management process 12 refers to the VM table region T5 to determine whether or not the target virtual server corresponds to the VM type of “WEB” (S92). If the type of the target virtual sever does not correspond to the WEB server (NO in S92), the virtual system operation state management process 12 outputs an instruction for controlling the virtual server to be brought into the temporarily stopped state to the virtual-environment management server 40 (S93). Then, the virtual system operation state management process 12 updates the operation state of the virtual server in the VM table region T5 from the operating state to the temporarily stopped state (S94). After the processing in S92 to S94 is performed for the target virtual servers, the virtual system operation state management process 12 updates the operation state of the target virtual system in the virtual system operation state table region T4 from the operating state to the temporarily stopped state (S95).

A description will be given of a case where an instruction for controlling the virtual system indicated by the virtual system ID “system3”, which has been activated in S75 in FIG. 15, to be brought into the temporarily stopped state is provided. The virtual system operation state management process 12 refers to the VM table region T5 in FIG. 8 to detect the virtual server vm7 which does not correspond to the VM type of “WEB” from among the virtual servers vm6 and vm7 which configure the virtual system indicated by the virtual system ID “system3” (S92). Then, the virtual system operation state management process 12 outputs an instruction for controlling the virtual server vm7 to be brought into the temporarily stopped state to the virtual-environment management server 40 (S93), and updates the operation state of the virtual server vm7 in the VM table region T5 from the operating state to the temporarily stopped state (S94).

As described above, an activation management apparatus (authentication server 10) included in an activation management system according to the present embodiment includes a processor. The processor is configured to start, in response to a first access request for accessing from a client device to a target device that is in a first state in which the target server is stopped, user authentication processing for authenticating a user of the client device and transmit a first instruction for bringing the target server into a second state in which the target server is operating. The processor is configured to transmit, if the first access request is not permitted as a result of the user authentication processing, a second instruction for bringing the target server that is in the second state into a third state in which the target server is temporarily stopped. The processor is configured to transmit, if a second access request for accessing the target server is permitted, a third instruction for bringing the target server that is in the third state into the second state. The second access request is generated after the transmission of the second instruction.

According to the activation management system of the present embodiment, by performing the user authentication processing and the system activation processing in parallel, it is possible to shorten the waiting time until the user starts the usage of the service. That is, the authorized user may start the usage of the information processing service after the short waiting time without caring about the time for waiting for the activation of the system.

According to the activation management system of the present embodiment, by controlling the server in the operating state to be brought into the temporarily stopped state in a case where the user authentication fails, it is possible to avoid repetition of the system activation processing even when unauthorized users repeat access requests. In addition, it is possible to suppress the usage of the resources in the CPU, the memory, and the like by controlling the server to be brought into the temporarily stopped state. According to the activation management system of the present embodiment, after the control of the server to be brought into the temporarily stopped state, the authorized user may start the usage of the information processing service after the short waiting time by providing the instruction for releasing the temporarily stopped state in the case where the user authentication is successfully made as a result of the user authentication processing.

Therefore, according to the activation management system of the present embodiment, it is possible to secure a user's convenience and to suppress the usage of the resources by activating and temporarily stopping the server in accordance with the usage state of the information processing service while shortening the user waiting time.

The activation management apparatus included in the activation management system according to the present embodiment is configured to start the user authentication processing and transmit the first instruction when the target server is in the stopped state. Therefore, by performing the user authentication processing and the system activation processing in parallel in the case where the target server is in the stopped state, it is possible to suppress the usage of the resources while shortening the waiting time until the user starts to use the service.

The activation management system according to the present embodiment includes managed systems each including first managed servers. The target server is one of the first managed servers. Therefore, according to the activation management system of the present embodiment, it is possible to significantly suppress the usage of the resources and to increase the number of virtual systems operable on the physical servers, by controlling servers in a part of the plurality of managed systems to be brought into the stopped state or the temporarily stopped state in accordance with the usage state of information processing services.

Each of the managed systems included in the activation management system according to the present embodiment further includes a second managed server different from the first managed servers. The second managed server is configured to receive an access request for accessing one of the first managed servers included in a corresponding managed system including the second managed server. The second managed server is controlled to be in the second state. The target server is one of the first managed servers different from the second managed server.

With such a configuration, since the server (the WEB server, for example) which receives the access request is in the operating state, the activation management apparatus included in the activation management system according to the present embodiment may receive the access request transmitted from the client device to the system.

The first managed servers included in the activation management system according to the present embodiment are virtual machines each of which is configured of one or more hardware units. With such a configuration, it is possible to suppress the usage of the resources in the physical servers by stopping the virtual servers in a case where no client uses the information processing services. Therefore, it is possible to more effectively use the resources in the physical servers.

The activation management system according to the present embodiment further includes an environment management apparatus (virtual-environment management server 40) configured to control the target server in accordance with the first instruction, the second instruction, and the third instruction. The activation management apparatus is configured to transmit the first instruction, the second instruction, and the third instruction to the environment management apparatus. With such a configuration, it is possible to control the states of the management target servers via the virtual-environment management server 40 for managing the virtual environment.

The activation management apparatus included in the activation management system according to the present embodiment is further configured to transmit, when no access request is permitted to access a first managed server included in a second managed system among the managed systems, a fourth instruction for bringing the first managed server included in the second managed system into the first state. With such a configuration, it is possible to perform the control to stop a server among the servers which configure the system in the case where there is no client which uses the information processing services.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An activation management system, comprising:
an activation management apparatus including:
a processor configured to
start, in response to a first access request for accessing from a client device to a target server that is in a first state in which the target server is stopped, user authentication processing for authenticating a user of the client device and transmit a first instruction for bringing the target server into a second state in which the target server is operating,
transmit, if the first access request is not permitted as a result of the user authentication processing, a second instruction for bringing the target server that is in the second state into a third state in which the target server is temporarily stopped, and
transmit, if a second access request for accessing the target server is permitted, a third instruction for bringing the target server that is in the third state into the second state, the second access request being generated after the transmission of the second instruction.

2. The activation management system according to claim 1, further comprising:
managed systems each including first managed servers,
wherein
the target server is one of the first managed servers.

3. The activation management system according to claim 2, wherein
each of the managed systems further includes a second managed server different from the first managed servers, the second managed server being configured to receive an access request for accessing one of the first managed servers included in a corresponding managed system including the second managed server, and
the processor is further configured to
select a first managed system from among the managed systems in response to the first access request, the first managed system including the second managed server that has received the first access request, and
select the target server from among the first managed servers included in the first managed system.

4. The activation management system according to claim 3, wherein
the second managed server is configured of at least one physical device and is controlled to be in the second state.

5. The activation management system according to claim 2, wherein
the first managed servers are virtual machines each of which is configured of one or more hardware units.

6. The activation management system according to claim 1, further comprising:
an environment management apparatus configured to
control the target server in accordance with the first instruction, the second instruction, and the third instruction,
wherein
the processor is configured to
transmit the first instruction, the second instruction, and the third instruction to the environment management apparatus.

7. The activation management system according to claim 2, wherein the processor is further configured to
transmit, when no access request is permitted to access a first managed server included in a second managed system among the managed systems, a fourth instruction for bringing the first managed server into the first state.

8. An activation management method, comprising:
starting by an activation management apparatus, in response to a first access request for accessing from a client device to a target server that is in a first state in which the target server is stopped, user authentication processing for authenticating a user of the client device and transmitting a first instruction for bringing the target server into a second state in which the target server is operating;
transmitting, if the first access request is not permitted as a result of the user authentication processing, a second instruction for bringing the target server that is in the second state into a third state in which the target server is temporarily stopped; and
transmitting, if a second access request for accessing the target server is permitted, a third instruction for bringing the target server that is in the third state into the second state, the second access request being generated after the transmission of the second instruction.

9. The activation management method according to claim 8, further comprising:
selecting a first managed system from among managed systems in response to the first access request, the first managed system including first managed servers and a second managed server that has received the first access request, the second managed server being different from the first managed servers; and
selecting the target server from among the first managed servers.

10. The activation management method according to claim 8, wherein
the activation management apparatus transmits the first instruction, the second instruction, and the third instruction to an environment management apparatus configured to control the target server in accordance with the first instruction, the second instruction, and the third instruction.

11. The activation management method according to claim 8, further comprising:
transmitting, when no access request is permitted to access a first managed server, a fourth instruction for bringing the first managed server into the first state.

12. A computer-readable recording medium having stored therein a program for causing a computer to execute a process, the process comprising:
starting, in response to a first access request for accessing from a client device to a target server that is in a first state in which the target server is stopped, user authentication processing for authenticating a user of the client device and transmitting a first instruction for bringing the target server into a second state in which the target server is operating;
transmitting, if the first access request is not permitted as a result of the user authentication processing, a second instruction for bringing the target server that is in the second state into a third state in which the target server is temporarily stopped; and
transmitting, if a second access request for accessing the target server is permitted, a third instruction for bringing the target server that is in the third state into the second state, the second access request being generated after the transmission of the second instruction.

13. The computer-readable recording medium according to claim 12, the process further comprising:
selecting a first managed system from among managed systems in response to the first access request, the first managed system including first managed servers and a second managed server that has received the first access request, the second managed server being different from the first managed servers; and
selecting the target server from among the first managed servers.

14. The computer-readable recording medium according to claim 12, wherein
the computer transmits the first instruction, the second instruction, and the third instruction to an environment management apparatus configured to control the target server in accordance with the first instruction, the second instruction, and the third instruction.

15. The computer-readable recording medium according to claim 12, the process further comprising:
transmitting, when no access request is permitted to access a first managed server, a fourth instruction for bringing the first managed server into the first state.
